(19) United States
(12) Patent Application Publication
(10) Pub. No.: US 2025/0254633 A1
(43) Pub. Date: Aug. 7, 2025

(54) SIGNAL SENDING METHOD AND APPARATUS, AND TERMINAL AND NETWORK-SIDE DEVICE

(71) Applicant: VIVO MOBILE COMMUNICATION CO., LTD., Dongguan (CN)

(72) Inventors: Yinhui LIU, Dongguan (CN); Gen LI, Dongguan (CN); Zichao JI, Dongguan (CN); Zijian HE, Dongguan (CN)

(21) Appl. No.: 19/188,044

(22) Filed: Apr. 24, 2025

Related U.S. Application Data
(63) Continuation of application No. PCT/CN2023/125993, filed on Oct. 23, 2023.

(30) Foreign Application Priority Data
Oct. 25, 2022 (CN) 202211311703.7

(51) Int. Cl. H04W 52/34

(52) U.S. Cl. CPC H04W 52/346

(57) ABSTRACT

Provided are a signal sending method and apparatus, a terminal, and a network-side device. The signal sending method includes: determining an upper power spectral density limit and/or a power spectral density for sending a first signal, by a first terminal based on first information; and sending, by the first terminal, the first signal based on the upper power spectral density limit and/or the power spectral density.

### CROSS-REFERENCE TO RELATED APPLICATIONS

This application is a continuation of International Patent Application No. PCT/CN2023/125993, filed on Oct. 23, 2023, which claims priority to Chinese Patent Application No. 202211311703.7, filed in China on Oct. 25, 2022, both of which are incorporated herein by reference in their entireties.

### TECHNICAL FIELD

This application pertains to the field of communication technologies, and specifically relates to a signal sending method and apparatus, a terminal, and a network-side device.

### BACKGROUND

With the device to device (D2D) communication technology, for example, sidelink (SL) communication, data may be directly transmitted between two terminals (which may also be referred to as user equipment (UE)), and the data does not need to be first sent to a base station and then forwarded through a core network.

### SUMMARY

Embodiments of this application provide a signal sending method and apparatus, a terminal, and a network-side device.

According to a first aspect, a signal sending method is provided and is applied to a first terminal. The method includes:
determining an upper power spectral density limit and/or a power spectral density for sending a first signal, by the first terminal based on first information; and
sending, by the first terminal, the first signal based on the upper power spectral density limit and/or the power spectral density.

The first information includes at least one of the following:
the upper power spectral density limit and/or the power spectral density for sending the first signal;
a relationship between the upper power spectral density limit and reference signal received power (RSRP), and/or a relationship between the power spectral density and reference signal received power RSRP;
a relationship between the upper power spectral density limit and a pathloss, and/or a relationship between the power spectral density and a pathloss;
a relationship between the upper power spectral density limit and a terminal received beam, and/or a relationship between the power spectral density and a terminal received beam;
a relationship between the upper power spectral density limit and a service type, and/or a relationship between the power spectral density and a service type;
a relationship between the upper power spectral density limit and a service priority, and/or a relationship between the power spectral density and a service priority;
a relationship between the upper power spectral density limit and a service congestion degree, and/or a relationship between the power spectral density and a service congestion degree;
a relationship between the upper power spectral density limit and received signal strength, and/or a relationship between the power spectral density and received signal strength;
a relationship between the upper power spectral density limit and a channel busy degree, and/or a relationship between the power spectral density and a channel busy degree;
a relationship between the upper power spectral density limit and information about a time domain location for sending the first signal, and/or a relationship between the power spectral density and information about a time domain location for sending the first signal;
a relationship between the upper power spectral density limit and information about a frequency domain location for sending the first signal, and/or a relationship between the power spectral density and information about a frequency domain location for sending the first signal;
transmit power and/or maximum transmit power for sending the first signal; or
information about a frequency domain width for sending the first signal, where the information about the frequency domain width includes at least one of the following: a bandwidth, a quantity of physical resource blocks, or a sub-channel size.

According to a second aspect, a signal sending apparatus is provided, including:
a first execution module, configured to determine an upper power spectral density limit and/or a power spectral density for sending a first signal, based on first information; and
a first transmission module, configured to send the first signal based on the upper power spectral density limit and/or the power spectral density.

The first information includes at least one of the following:
the upper power spectral density limit and/or the power spectral density for sending the first signal;
a relationship between the upper power spectral density limit and reference signal received power RSRP, and/or a relationship between the power spectral density and reference signal received power RSRP;
a relationship between the upper power spectral density limit and a pathloss, and/or a relationship between the power spectral density and a pathloss;
a relationship between the upper power spectral density limit and a terminal received beam, and/or a relationship between the power spectral density and a terminal received beam;
a relationship between the upper power spectral density limit and a service type, and/or a relationship between the power spectral density and a service type;
a relationship between the upper power spectral density limit and a service priority, and/or a relationship between the power spectral density and a service priority;
a relationship between the upper power spectral density limit and a service congestion degree, and/or a relationship between the power spectral density and a service congestion degree;
a relationship between the upper power spectral density limit and received signal strength, and/or a relationship between the power spectral density and received signal strength;
a relationship between the upper power spectral density limit and a channel busy degree, and/or a relationship between the power spectral density and a channel busy degree;
a relationship between the upper power spectral density limit and information about a time domain location for sending the first signal, and/or a relationship between the power spectral density and information about a time domain location for sending the first signal;
a relationship between the upper power spectral density limit and information about a frequency domain location for sending the first signal, and/or a relationship between the power spectral density and information about a frequency domain location for sending the first signal;
transmit power and/or maximum transmit power for sending the first signal; or
information about a frequency domain width for sending the first signal, where the information about the frequency domain width includes at least one of the following: a bandwidth, a quantity of physical resource blocks, or a sub-channel size.

According to a third aspect, a signal sending method is provided and is applied to a network-side device. The method includes:
sending, by the network-side device, first information to a first terminal, where the first information is used to indicate, to the first terminal, an upper power spectral density limit and/or a power spectral density for sending a first signal.

The first information includes at least one of the following:
the upper power spectral density limit and/or the power spectral density for sending the first signal;
a relationship between the upper power spectral density limit and reference signal received power RSRP, and/or a relationship between the power spectral density and reference signal received power RSRP;
a relationship between the upper power spectral density limit and a pathloss, and/or a relationship between the power spectral density and a pathloss;
a relationship between the upper power spectral density limit and a terminal received beam, and/or a relationship between the power spectral density and a terminal received beam;
a relationship between the upper power spectral density limit and a service type, and/or a relationship between the power spectral density and a service type;
a relationship between the upper power spectral density limit and a service priority, and/or a relationship between the power spectral density and a service priority;
a relationship between the upper power spectral density limit and a service congestion degree, and/or a relationship between the power spectral density and a service congestion degree;
a relationship between the upper power spectral density limit and received signal strength, and/or a relationship between the power spectral density and received signal strength;
a relationship between the upper power spectral density limit and a channel busy degree, and/or a relationship between the power spectral density and a channel busy degree;
a relationship between the upper power spectral density limit and information about a time domain location for sending the first signal, and/or a relationship between the power spectral density and information about a time domain location for sending the first signal;
a relationship between the upper power spectral density limit and information about a frequency domain location for sending the first signal, and/or a relationship between the power spectral density and information about a frequency domain location for sending the first signal;
transmit power and/or maximum transmit power for sending the first signal; or
information about a frequency domain width for sending the first signal, where the information about the frequency domain width includes at least one of the following: a bandwidth, a quantity of physical resource blocks, or a sub-channel size.

According to a fourth aspect, a signal sending apparatus is provided, including:
a second execution module, configured to determine first information; and
a second transmission module, configured to send the first information to a first terminal, where the first information is used to indicate, to the first terminal, an upper power spectral density limit and/or a power spectral density for sending a first signal.

The first information includes at least one of the following:
the upper power spectral density limit and/or the power spectral density for sending the first signal;
a relationship between the upper power spectral density limit and reference signal received power RSRP, and/or a relationship between the power spectral density and reference signal received power RSRP;
a relationship between the upper power spectral density limit and a pathloss, and/or a relationship between the power spectral density and a pathloss;
a relationship between the upper power spectral density limit and a terminal received beam, and/or a relationship between the power spectral density and a terminal received beam;
a relationship between the upper power spectral density limit and a service type, and/or a relationship between the power spectral density and a service type;
a relationship between the upper power spectral density limit and a service priority, and/or a relationship between the power spectral density and a service priority;
a relationship between the upper power spectral density limit and a service congestion degree, and/or a relationship between the power spectral density and a service congestion degree;
a relationship between the upper power spectral density limit and received signal strength, and/or a relationship between the power spectral density and received signal strength;
a relationship between the upper power spectral density limit and a channel busy degree, and/or a relationship between the power spectral density and a channel busy degree;
a relationship between the upper power spectral density limit and information about a time domain location for sending the first signal, and/or a relationship between the power spectral density and information about a time domain location for sending the first signal;
a relationship between the upper power spectral density limit and information about a frequency domain location for sending the first signal, and/or a relationship between the power spectral density and information about a frequency domain location for sending the first signal;
transmit power and/or maximum transmit power for sending the first signal; or
information about a frequency domain width for sending the first signal, where the information about the frequency domain width includes at least one of the following: a bandwidth, a quantity of physical resource blocks, or a sub-channel size.

According to a fifth aspect, a signal sending method is provided and is applied to a second terminal. The method includes:
sending, by the second terminal, first information to a first terminal, where the first information is used to indicate, to the first terminal, an upper power spectral density limit and/or a power spectral density for sending a first signal.

The first information includes at least one of the following:
the upper power spectral density limit and/or the power spectral density for sending the first signal;
a relationship between the upper power spectral density limit and reference signal received power RSRP, and/or a relationship between the power spectral density and reference signal received power RSRP;
a relationship between the upper power spectral density limit and a pathloss, and/or a relationship between the power spectral density and a pathloss;
a relationship between the upper power spectral density limit and a terminal received beam, and/or a relationship between the power spectral density and a terminal received beam;
a relationship between the upper power spectral density limit and a service type, and/or a relationship between the power spectral density and a service type;
a relationship between the upper power spectral density limit and a service priority, and/or a relationship between the power spectral density and a service priority;
a relationship between the upper power spectral density limit and a service congestion degree, and/or a relationship between the power spectral density and a service congestion degree;
a relationship between the upper power spectral density limit and received signal strength, and/or a relationship between the power spectral density and received signal strength;
a relationship between the upper power spectral density limit and a channel busy degree, and/or a relationship between the power spectral density and a channel busy degree;
a relationship between the upper power spectral density limit and information about a time domain location for sending the first signal, and/or a relationship between the power spectral density and information about a time domain location for sending the first signal;
a relationship between the upper power spectral density limit and information about a frequency domain location for sending the first signal, and/or a relationship between the power spectral density and information about a frequency domain location for sending the first signal;
transmit power and/or maximum transmit power for sending the first signal; or
information about a frequency domain width for sending the first signal, where the information about the frequency domain width includes at least one of the following: a bandwidth, a quantity of physical resource blocks, or a sub-channel size.

According to a sixth aspect, a signal sending apparatus is provided, including:
a third execution module, configured to determine first information; and
a third transmission module, configured to send the first information to a first terminal, where the first information is used to indicate, to the first terminal, an upper power spectral density limit and/or a power spectral density for sending a first signal.

The first information includes at least one of the following:
the upper power spectral density limit and/or the power spectral density for sending the first signal;
a relationship between the upper power spectral density limit and reference signal received power RSRP, and/or a relationship between the power spectral density and reference signal received power RSRP;
a relationship between the upper power spectral density limit and a pathloss, and/or a relationship between the power spectral density and a pathloss;
a relationship between the upper power spectral density limit and a terminal received beam, and/or a relationship between the power spectral density and a terminal received beam;
a relationship between the upper power spectral density limit and a service type, and/or a relationship between the power spectral density and a service type;
a relationship between the upper power spectral density limit and a service priority, and/or a relationship between the power spectral density and a service priority;
a relationship between the upper power spectral density limit and a service congestion degree, and/or a relationship between the power spectral density and a service congestion degree;
a relationship between the upper power spectral density limit and received signal strength, and/or a relationship between the power spectral density and received signal strength;
a relationship between the upper power spectral density limit and a channel busy degree, and/or a relationship between the power spectral density and a channel busy degree;
a relationship between the upper power spectral density limit and information about a time domain location for sending the first signal, and/or a relationship between the power spectral density and information about a time domain location for sending the first signal;
a relationship between the upper power spectral density limit and information about a frequency domain location for sending the first signal, and/or a relationship between the power spectral density and information about a frequency domain location for sending the first signal;
transmit power and/or maximum transmit power for sending the first signal; or
information about a frequency domain width for sending the first signal, where the information about the frequency domain width includes at least one of the following: a bandwidth, a quantity of physical resource blocks, or a sub-channel size.

According to a seventh aspect, a terminal is provided. The terminal includes a processor and a memory. The memory stores a program or instructions capable of running on the processor, and the program or the instructions, when executed by the processor, implement the method according to the first aspect, or implement the step of the method according to the fifth aspect.

According to an eighth aspect, a terminal is provided, including a processor and a communication interface. The processor is configured to determine an upper power spectral density limit and/or a power spectral density for sending a first signal, based on first information. The communication interface is configured to send the first signal based on the upper power spectral density limit and/or the power spectral density.

According to a ninth aspect, a network-side device is provided. The network-side device includes a processor and a memory. The memory stores a program or instructions capable of running on the processor, and the program or the instructions, when executed by the processor, implement the step of the method according to the third aspect.

According to a tenth aspect, a network-side device is provided, including a processor and a communication interface. The processor is configured to determine first information. The communication interface is configured to send the first information to a first terminal, where the first information is used to indicate, to the first terminal, an upper power spectral density limit and/or a power spectral density for sending a first signal.

According to an eleventh aspect, a signal sending system is provided, including a first terminal and a network-side device. The terminal may be configured to perform the steps of the signal sending method according to the first aspect, and the network-side device may be configured to perform the step of the signal sending method according to the third aspect.

According to a twelfth aspect, a readable storage medium is provided. The readable storage medium stores a program or instructions, and the program or the instructions, when executed by a processor, implement the steps of the method according to the first aspect, or implement the step of the method according to the third aspect, or implement the step of the method according to the fifth aspect.

According to a thirteenth aspect, a chip is provided. The chip includes a processor and a communication interface, and the communication interface is coupled to the processor. The processor is configured to run a program or instructions to implement the method according to the first aspect, or to implement the method according to the third aspect, or to implement the method according to the fifth aspect.

According to a fourteenth aspect, a computer program/program product is provided. The computer program/program product is stored in a storage medium. The computer program/program product is executed by at least one processor to implement the signal sending method according to the first aspect, or to implement the signal sending method according to the third aspect, or to implement the step of the signal sending method according to the fifth aspect.

### BRIEF DESCRIPTION OF DRAWINGS

FIG. 1 is a schematic diagram of a structure of a wireless communication system applicable to an embodiment of this application;

FIG. 2 is a schematic flowchart of a signal sending method according to an embodiment of this application;

FIG. 3 is a schematic diagram of a structure of a signal sending apparatus according to an embodiment of this application;

FIG. 4 is a schematic flowchart of another signal sending method according to an embodiment of this application;

FIG. 5 is a schematic diagram of a structure of another signal sending apparatus according to an embodiment of this application;

FIG. 6 is a schematic flowchart of another signal sending method according to an embodiment of this application;

FIG. 7 is a schematic diagram of a structure of another signal sending apparatus according to an embodiment of this application;

FIG. 8 is a schematic diagram of a structure of a communication device according to an embodiment of this application;

FIG. 9 is a schematic diagram of a structure of a terminal for implementing an embodiment of this application; and

FIG. 10 is a schematic diagram of a structure of a network-side device for implementing an embodiment of this application.

### DESCRIPTION OF EMBODIMENTS

The following clearly describes technical solutions in embodiments of this application with reference to accompanying drawings in the embodiments of this application. Clearly, the described embodiments are merely some rather than all of the embodiments of this application. All other embodiments obtained by a person of ordinary skill in the art based on the embodiments of this application shall fall within the protection scope of this application.

The terms “first”, “second”, and the like in the specification and claims of this application are used to distinguish between similar objects instead of describing a specified order or sequence. It should be understood that, terms used in this way may be interchangeable under appropriate circumstances, so that the embodiments of this application can be implemented in an order other than that illustrated or described herein. Moreover, the terms “first” and “second” typically distinguish between objects of one category rather than limiting a quantity of objects. For example, there may be one or more first objects. In addition, in the specification and claims, “and/or” represents at least one of connected objects, and the character “/” generally represents an “or” relationship between associated objects.

It should be noted that, a technology described in embodiments of this application is not limited to a long term evolution (LTE)/LTE-advanced (LTE-A) system, and may be further applied to other wireless communication systems, such as a code division multiple access (, CDMA) system, a time division multiple access (TDMA) system, a frequency division multiple access (, FDMA) system, an orthogonal frequency division multiple access (OFDMA) system, a single-carrier frequency division multiple access (SC-FDMA) system, and another system. The terms “system” and “network” are often used interchangeably in the embodiments of this application. A technology described may be used for the systems and radio technologies described above, as well as other systems and radio technologies. The following describes a new radio (NR) system for illustrative purposes, and NR terms are used in most of the following descriptions. However, these technologies are also applicable to applications such as a 6^{th} generation (6G) communication system other than NR system applications.

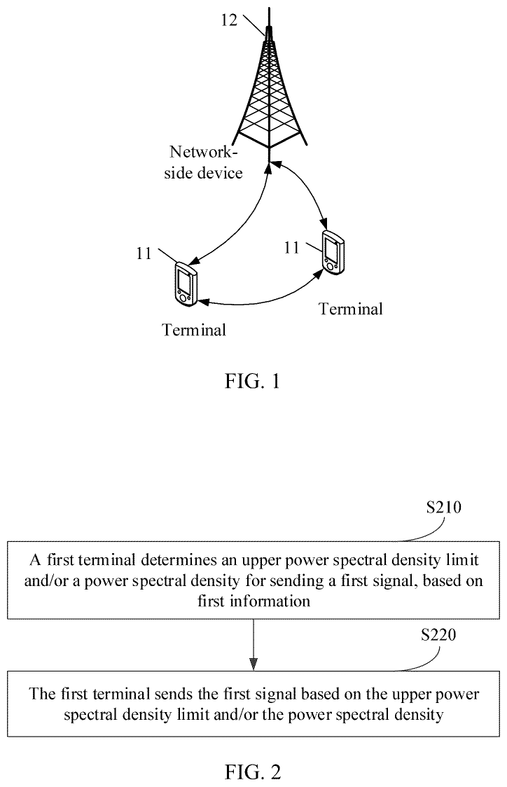

FIG. 1 is a block diagram of a wireless communication system applicable to an embodiment of this application. The wireless communication system includes a terminal 11 and a network-side device 12. The terminal 11 may be a mobile phone, a tablet personal computer, a laptop computer or referred to as a notebook computer, a personal digital assistant PDA), a palmtop computer, a netbook, an ultra-mobile personal computer (UMPC), a mobile internet device (MID), an augmented reality (AR)/virtual reality (VR) device, a robot, a wearable device, vehicle user equipment (VUE), pedestrian user equipment (PUE), a smart home (a home device with a wireless communication function, such as a refrigerator, a television, a laundry machine, or a furniture), a gaming console, a personal computer (PC), a teller machine, a self-service machine, or another terminal-side device. The wearable device includes a smart watch, a smart band, a smart headset, smart glasses, smart jewelry (a smart bracelet, a smart wristlet, a smart ring, a smart necklace, a smart anklet, a smart leglet, and the like), a smart wristband, smart clothing, and the like. It should be noted that a specific type of the terminal 11 is not limited in this embodiment of this application. The network-side device 12 may include an access network device or a core network device. The access network device 12 may also be referred to as a radio access network device, a radio access network (RAN), a radio access network function, or a radio access network unit. The access network device 12 may include a base station, a WLAN access point, a WiFi node, or the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a transmitting receiving point (TRP), or another appropriate term in the field. Provided that a same technical effect is achieved, the base station is not limited to a specific technical term. It should be noted that in the embodiments of this application, only a base station in an NR system is used as an example for description, and a specific type of the base station is not limited. The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function (PCRF) unit, an edge application server discovery function (EASDF), unified data management (UDM), a unified data repository (UDR), a home subscriber server (HSS), a centralized network configuration (CNC), a network repository function (NRF), a network exposure function (NEF), a local NEF (Local NEF or L-NEF), a binding support function (BSF), an application function (AF), and the like. It should be noted that in the embodiments of this application, only a core network device in an NR system is used as an example for description, and a specific type of the core network device is not limited.

With reference to the accompanying drawings, a signal sending method and apparatus, a terminal, and a network-side device provided in the embodiments of this application are described below in detail by using some embodiments and application scenarios thereof.

As shown in FIG. 2, an embodiment of this application provides a signal sending method. The method is performed by a first terminal. In other words, the method may be performed by software or hardware installed in the terminal. The method includes the following steps.

S210: The first terminal determines an upper power spectral density limit and/or a power spectral density for sending a first signal, based on first information.

In an implementation, the first terminal may obtain the first information from a network-side device, and the first information is carried by at least one of the following sent by the network-side device:
radio resource control (RRC) signaling;
medium access control (MAC) signaling; or
downlink control information (DCI) signaling.

In another implementation, the first terminal may obtain the first information from a second terminal, and the first information is carried by at least one of the following sent by the second terminal:
radio resource control RRC signaling;
medium access control MAC signaling; or
physical layer signaling, where for example, if the first terminal communicates with the second terminal over a sidelink (SL) interface, the physical layer signaling may be sidelink control information (SCI) signaling.

In another implementation, the first information may alternatively be configured for the first terminal in a manner of pre-definition in a protocol or pre-configuration, for example, may be written in a subscriber identity module (SIM) card, or may be written in a terminal model, and is pre-configured as a default parameter. After a terminal accesses a network, the network may perform configuration modification on each parameter in the first information.

The power spectral density is power of a unit frequency resource. The unit frequency resource herein may be based on a common frequency unit, for example, Hz, kHz, or MHz; or may be based on a frequency unit that has a subcarrier spacing (SCS), for example,
a subcarrier spacing, where a frequency resource unit corresponding to the subcarrier spacing may be 15 kHz, 30 kHz, 60 kHz, or the like;
a physical resource block (PRB), where because each PRB includes 12 subcarriers, a frequency resource unit corresponding to the physical resource block may be 15 kHz*12, 30 kHz*12, 60 kHz*12, or the like; or
a sub-channel, where because each sub-channel includes N_PRB PRBs, a frequency resource unit corresponding to the sub-channel may be 15 kHz*12*N_PRB, 30 kHz*12*N_PRB, 60 kHz*12*N_PRB, or the like.

S220: The first terminal sends the first signal based on the upper power spectral density limit and/or the power spectral density.

The first signal may be a signal used by the first terminal to perform device to device communication, and the first terminal may send the first signal in a plurality of manners. In an implementation, the first signal is a signal transmitted based on one of the following:
a sidelink;
WiFi;
ultra-wideband (UWB) transmission;
a heterogeneous network (HetNet);
cellular communication; or
Bluetooth transmission.

The first terminal may determine the upper power spectral density limit and/or the power spectral density based on the first information in a plurality of manners. Only several specific implementations are provided in this embodiment of this application.

In an implementation, the first information may include the upper power spectral density limit psdS1TxThresliold for sending the first signal. The upper power spectral density limit may be in units of dBm/MHz, dBm/PRB, or dBm/subcarrier.

After obtaining the first information, the first terminal may transmit the first signal by using the psdS1TxThreshold as the upper power spectral density limit. The psdS1TxThreshold may be configured in one of the following manners: pre-definition in a protocol; pre-configuration; RRC signaling, MAC signaling, or DCI signaling sent by the network-side device; or RRC signaling, MAC signaling, or physical layer signaling sent by the second terminal.

In another implementation, the first information may include the power spectral density psdS1Tx for sending the first signal, and the power spectral density may be in units of dBm/MHz, dBm/PRB, or dBm/subcarrier.

After obtaining the first information, the first terminal may transmit the first signal by using the psdS1Tx in the first information as the power spectral density. The psdS1Tx may be configured in one of the following manners: pre-definition in a protocol; pre-configuration; RRC signaling, MAC signaling, or DCI signaling sent by the network-side device; or RRC signaling, MAC signaling, or physical layer signaling sent by the second terminal.

In another implementation, the first information may include a relationship f1 between the upper power spectral density limit and reference signal received power (RSRP), that is, psdS1TxThreshold=f1(RSRP), and/or a relationship f2 between the power spectral density and RSRP, that is, psdS1Tx=f2(RSRP), where f1 and/or f2 may be a mathematical expression, a mapping table, or the like. The RSRP may be RSRP in Uu communication of the first terminal.

It should be noted that larger RSRP indicates that the first terminal is closer to the network-side device and that the psdS1TxThreshold obtained through calculation should be lower.

The first terminal may calculate the psdS1TxThreshold and/or the psdS1Tx based on f1 and/or f2 and the RSRP, and transmit the first signal by using the psdS1TxThreshold and/or the psdS1Tx as the upper power spectral density limit and/or the power spectral density.

In another implementation, the first information may include a relationship f3 between the upper power spectral density limit and RSRP, and/or a relationship f4 between the power spectral density and RSRP, where f3 and/or f4 may be a mathematical expression, a mapping table, or the like. A difference between f3 and/or f4 and f1 and/or f2 in the foregoing implementation lies in that f3 and/or f4 include/includes at least one configurable parameter a1, a2, . . . , or an, that is, psdS1TxThreshold=f1(RSRP, ai, . . . ), and/or psdS1Tx=f2 (RSRP, aj, . . . ). The first information may include the at least one configurable parameter a1, a2, . . . , or an.

The first terminal may calculate the psdS1TxThreshold and/or the psdS1Tx based on f3 and/or f4, the parameter a1, a2, . . . , or an, and the RSRP, and transmit the first signal by using the psdS1TxThreshold and/or the psdS1Tx as the upper power spectral density limit and/or the power spectral density.

In another implementation, the RSRP in the foregoing embodiment may be replaced with another parameter, and the first information may include at least one of the following:
a relationship between the upper power spectral density limit and reference signal received power RSRP, and/or a relationship between the power spectral density and reference signal received power RSRP;
a relationship between the upper power spectral density limit and a pathloss, and/or a relationship between the power spectral density and a pathloss;
a relationship between the upper power spectral density limit and a terminal received beam, and/or a relationship between the power spectral density and a terminal received beam;
a relationship between the upper power spectral density limit and a service type, and/or a relationship between the power spectral density and a service type, where the service type may be classified in various manners, for example, may be classified based on quality of service (QoS);
a relationship between the upper power spectral density limit and a service priority, and/or a relationship between the power spectral density and a service priority;
a relationship between the upper power spectral density limit and a service congestion degree, and/or a relationship between the power spectral density and a service congestion degree, where the service congestion degree may be a congestion degree of a service on a resource pool, for example, a sidelink resource pool, of a corresponding communication interface;
a relationship between the upper power spectral density limit and received signal strength, and/or a relationship between the power spectral density and received signal strength, where the received signal strength may be a received signal strength indicator on a resource pool of a corresponding communication interface;
a relationship between the upper power spectral density limit and a channel busy degree, and/or a relationship between the power spectral density and a channel busy degree, where the channel busy degree may be a channel busy ratio (CBR) on a resource pool of a corresponding communication interface;
a relationship between the upper power spectral density limit and information about a time domain location for sending the first signal, and/or a relationship between the power spectral density and information about a time domain location for sending the first signal, where the information about the time domain location may be, for example, an index of a slot;
a relationship between the upper power spectral density limit and information about a frequency domain location for sending the first signal, and/or a relationship between the power spectral density and information about a frequency domain location for sending the first signal, where the information about the frequency domain location may be, for example, a frequency range, a PRB index, and a sub-channel index;
transmit power and/or maximum transmit power for sending the first signal; or
information about a frequency domain width (freqWidth) for sending the first signal, where the information about the frequency domain width includes at least one of the following: a bandwidth, a quantity of physical resource blocks, or a sub-channel size.

The first terminal may calculate the psdS1TxThreshold and/or the psdS1Tx based on any one or combination of the items in the first information, for example, a combination of the RSRP and other information, and transmit the first signal by using the psdS1TxThreshold and/or the psdS1Tx as the upper power spectral density limit and/or the power spectral density.

It should be noted that the relationship in the first information may be represented as a mathematical expression or a mapping table, which is not specifically limited.

The relationship between the upper power spectral density limit and the pathloss is used as an example. A larger pathloss indicates that the first terminal is closer to the network-side device and that the psdS1TxThreshold obtained through calculation should be higher.

The relationship between the upper power spectral density limit and the service type, or the relationship between the upper power spectral density limit and the service priority is used as an example. Higher QoS of a service or a higher service priority indicates that the psdS1TxThreshold obtained through calculation should be higher.

The relationship between the upper power spectral density limit and the service congestion degree, or the relationship between the upper power spectral density limit and the channel busy degree is used as an example. A higher congestion degree of a service on an SL resource pool or a higher channel busy ratio on an SL resource pool indicates that the psdS1TxThreshold obtained through calculation should be lower.

The relationship between the upper power spectral density limit and the received signal strength is used as an example. A higher RSSI on an SL resource pool indicates that the psdS1TxThreshold obtained through calculation should be lower.

In another implementation, after calculating the psdS1TxThreshold and/or the psdS1Tx based on the foregoing implementation, the first terminal further needs to consider power control.

The first terminal calculates transmit power powPowerCtrl and a corresponding power spectral density powPowerCtrl=powpowerCtrl/freqWidth based on power control and a frequency domain width for transmitting the first signal. A unit of the power spectral density psdPowCtrl and units of the psdSlTxThreshold and the psdSlTx each may be correspondingly MHz, a quantity of PRBs, a subcarrier size, or the like.

The first terminal compares the psdPowCtrl with the psdS1TxThreshold and/or the psdS1Tx obtained through calculation in the foregoing implementation, and selects a smaller one as an actual power spectral density to transmit the first signal.

The actual power spectral density=min(psdPowCtrl, psdS1Tx); or
the actual power spectral density=min(psdPowCtrl, psdS1TxThreshold).

In another implementation, in a case that power control is considered, after calculating the psdS1TxThreshold and/or the psdS1Tx based on the foregoing implementation, the first terminal multiplies the calculation result by a frequency domain width for transmitting the first signal, to obtain maximum transmit power powS1TxThreshold=psdS1TxThreshold×freqWidth and/or transmit power powS1Tx=psdS1Tx×freqWidth.

The first terminal compares the transmit power powPowerCtrl obtained through power control calculation with the powS1TxThreshold and/or the powS1Tx, and selects a smaller one as actual transmit power to transmit the first signal.

The actual transmit power=min(powPowerCtrl, PowS1Tx); or
the actual transmit power=min(powPowerCtrl, PowS1TxThreshold).

In another implementation, in a case that power control is considered, the first terminal may further determine, based on maximum transmit power maxTxPow obtained through power control and with reference to the psdS1TxThreshold and/or the psdS1Tx obtained through calculation, a maximum frequency domain width supported by the first terminal, for example, a maximum quantity of PRBs. The first terminal sends the first signal in a range of the maximum quantity of PRBs.

In an implementation, the first information may be configured for each of the following:
each terminal corresponds to first information of the terminal;
each frequency band corresponds to first information of the frequency band;
each carrier group corresponds to first information of the carrier group;
each carrier corresponds to first information of the carrier;
each bandwidth part corresponds to first information of the bandwidth part; or
each resource pool corresponds to first information of the resource pool.

In an implementation, a resource scheduled by the network-side device for the first signal overlaps another scheduled resource. In a case that the first terminal sends the first signal based on the upper power spectral density limit and/or the power spectral density, the first signal does not interfere with Uu communication of another terminal, or generates interference small enough. Therefore, the network-side device allows scheduling, to another terminal for performing Uu communication, of a time-frequency resource used to send the first signal.

It may be learned from the technical solution in the foregoing embodiment that, in this embodiment of this application, the upper power spectral density limit and/or the power spectral density for sending the first signal are/is determined based on the first information, and the first signal is sent based on the upper power spectral density limit and/or the power spectral density, so that the power spectral density for sending the first signal is effectively controlled, interference to other transmission in a same time-frequency resource as the sent first signal is reduced, and radio resource utilization is improved.

The signal sending method provided in the embodiments of this application may be performed by a signal sending apparatus. In the embodiments of this application, the signal sending apparatus provided in the embodiments of this application is described by using an example in which the signal sending apparatus performs the signal sending method.

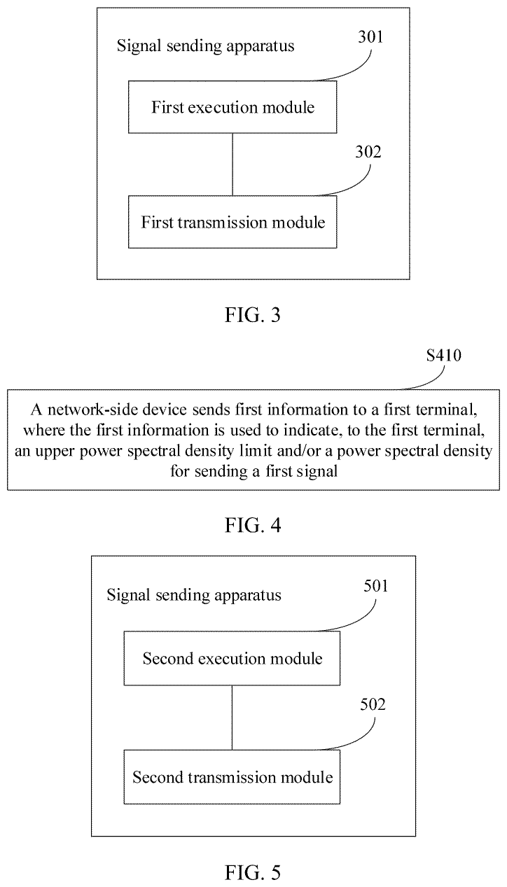

As shown in FIG. 3, the signal sending apparatus includes a first execution module 301 and a first transmission module 302.

The first execution module 301 is configured to determine an upper power spectral density limit and/or a power spectral density for sending a first signal, based on first information. The first transmission module 302 is configured to send the first signal based on the upper power spectral density limit and/or the power spectral density.

The first information includes at least one of the following:
the upper power spectral density limit and/or the power spectral density for sending the first signal;
a relationship between the upper power spectral density limit and reference signal received power RSRP, and/or a relationship between the power spectral density and reference signal received power RSRP;
a relationship between the upper power spectral density limit and a pathloss, and/or a relationship between the power spectral density and a pathloss;
a relationship between the upper power spectral density limit and a terminal received beam, and/or a relationship between the power spectral density and a terminal received beam;
a relationship between the upper power spectral density limit and a service type, and/or a relationship between the power spectral density and a service type;
a relationship between the upper power spectral density limit and a service priority, and/or a relationship between the power spectral density and a service priority;
a relationship between the upper power spectral density limit and a service congestion degree, and/or a relationship between the power spectral density and a service congestion degree;
a relationship between the upper power spectral density limit and received signal strength, and/or a relationship between the power spectral density and received signal strength;
a relationship between the upper power spectral density limit and a channel busy degree, and/or a relationship between the power spectral density and a channel busy degree;
a relationship between the upper power spectral density limit and information about a time domain location for sending the first signal, and/or a relationship between the power spectral density and information about a time domain location for sending the first signal;
a relationship between the upper power spectral density limit and information about a frequency domain location for sending the first signal, and/or a relationship between the power spectral density and information about a frequency domain location for sending the first signal;
transmit power and/or maximum transmit power for sending the first signal; or
information about a frequency domain width for sending the first signal, where the information about the frequency domain width includes at least one of the following: a bandwidth, a quantity of physical resource blocks, or a sub-channel size.

Optionally, each terminal corresponds to first information of the terminal;
each frequency band corresponds to first information of the frequency band;
each carrier group corresponds to first information of the carrier group;
each carrier corresponds to first information of the carrier;
each bandwidth part corresponds to first information of the bandwidth part; or
each resource pool corresponds to first information of the resource pool.

Optionally, the first information is carried by at least one of the following sent by the network-side device:
radio resource control RRC signaling;
medium access control MAC signaling; or
downlink control information DCI signaling.

Optionally, the first information is carried by at least one of the following sent by a second terminal:
radio resource control RRC signaling;
medium access control MAC signaling; or
physical layer signaling.

Optionally, the first signal is a signal transmitted based on one of the following:
a sidelink;
WiFi;
ultra-wideband transmission;
a heterogeneous network;
cellular communication; or
Bluetooth transmission.

It may be learned from the technical solution in the foregoing embodiment that, in this embodiment of this application, the upper power spectral density limit and/or the power spectral density for sending the first signal are/is determined based on the first information, and the first signal is sent based on the upper power spectral density limit and/or the power spectral density, so that the power spectral density for sending the first signal is effectively controlled, interference to other transmission in a same time-frequency resource as the sent first signal is reduced, and radio resource utilization is improved.

The signal sending apparatus in this embodiment of this application may be an electronic device, for example, an electronic device with an operating system; or
may be a component, for example, an integrated circuit or a chip, in an electronic device. The electronic device may be a terminal, or may be another device different from a terminal. For example, the terminal may include but is not limited to the foregoing listed types of the terminal 11. The another device may be a server, a network attached storage (NAS), or the like. This is not specifically limited in this embodiment of this application.

The signal sending apparatus provided in this embodiment of this application can implement processes implemented in the method embodiment in FIG. 2, and achieve same technical effects. To avoid repetition, details are not described herein again.

As shown in FIG. 4, an embodiment of this application provides a signal sending method. The method is performed by a network-side device. In other words, the method may be performed by software or hardware installed in the network-side device. The method includes the following steps.

S410: The network-side device sends first information to a first terminal, where the first information is used to indicate, to the first terminal, an upper power spectral density limit and/or a power spectral density for sending a first signal.

The first information includes at least one of the following:
the upper power spectral density limit and/or the power spectral density for sending the first signal;
a relationship between the upper power spectral density limit and reference signal received power RSRP, and/or a relationship between the power spectral density and reference signal received power RSRP;
a relationship between the upper power spectral density limit and a pathloss, and/or a relationship between the power spectral density and a pathloss;
a relationship between the upper power spectral density limit and a terminal received beam, and/or a relationship between the power spectral density and a terminal received beam;
a relationship between the upper power spectral density limit and a service type, and/or a relationship between the power spectral density and a service type;
a relationship between the upper power spectral density limit and a service priority, and/or a relationship between the power spectral density and a service priority;
a relationship between the upper power spectral density limit and a service congestion degree, and/or a relationship between the power spectral density and a service congestion degree;
a relationship between the upper power spectral density limit and received signal strength, and/or a relationship between the power spectral density and received signal strength;
a relationship between the upper power spectral density limit and a channel busy degree, and/or a relationship between the power spectral density and a channel busy degree;
a relationship between the upper power spectral density limit and information about a time domain location for sending the first signal, and/or a relationship between the power spectral density and information about a time domain location for sending the first signal;
a relationship between the upper power spectral density limit and information about a frequency domain location for sending the first signal, and/or a relationship between the power spectral density and information about a frequency domain location for sending the first signal;
transmit power and/or maximum transmit power for sending the first signal; or
information about a frequency domain width for sending the first signal, where the information about the frequency domain width includes at least one of the following: a bandwidth, a quantity of physical resource blocks, or a sub-channel size.

Optionally, each terminal corresponds to first information of the terminal;
each frequency band corresponds to first information of the frequency band;
each carrier group corresponds to first information of the carrier group;
each carrier corresponds to first information of the carrier;
each bandwidth part corresponds to first information of the bandwidth part; or
each resource pool corresponds to first information of the resource pool.

Optionally, the first information is carried by at least one of the following:
radio resource control RRC signaling;
medium access control MAC signaling; or
downlink control information DCI signaling.

Optionally, the first signal is a signal transmitted based on one of the following:
a sidelink;
WiFi;
ultra-wideband transmission;
a heterogeneous network;
cellular communication; or
Bluetooth transmission.

It may be learned from the technical solution in the foregoing embodiment that, in this embodiment of this application, the first information is sent to the first terminal, and the first information is used to indicate, to the first terminal, the upper power spectral density limit and/or the power spectral density for sending the first signal, so that the power spectral density for sending the first signal is effectively controlled, interference to other transmission in a same time-frequency resource as the sent first signal is reduced, and radio resource utilization is improved.

The signal sending method provided in the embodiments of this application may be performed by a signal sending apparatus. In the embodiments of this application, the signal sending apparatus provided in the embodiments of this application is described by using an example in which the signal sending apparatus performs the signal sending method.

As shown in FIG. 5, the signal sending apparatus includes a second execution module 501 and a second transmission module 502.

The second execution module 501 is configured to determine first information. The second transmission module 502 is configured to send the first information to a first terminal, where the first information is used to indicate, to the first terminal, an upper power spectral density limit and/or a power spectral density for sending a first signal.

The first information includes at least one of the following:
the upper power spectral density limit and/or the power spectral density for sending the first signal;
a relationship between the upper power spectral density limit and reference signal received power RSRP, and/or a relationship between the power spectral density and reference signal received power RSRP;
a relationship between the upper power spectral density limit and a pathloss, and/or a relationship between the power spectral density and a pathloss;
a relationship between the upper power spectral density limit and a terminal received beam, and/or a relationship between the power spectral density and a terminal received beam;
a relationship between the upper power spectral density limit and a service type, and/or a relationship between the power spectral density and a service type;
a relationship between the upper power spectral density limit and a service priority, and/or a relationship between the power spectral density and a service priority;
a relationship between the upper power spectral density limit and a service congestion degree, and/or a relationship between the power spectral density and a service congestion degree;
a relationship between the upper power spectral density limit and received signal strength, and/or a relationship between the power spectral density and received signal strength;
a relationship between the upper power spectral density limit and a channel busy degree, and/or a relationship between the power spectral density and a channel busy degree;
a relationship between the upper power spectral density limit and information about a time domain location for sending the first signal, and/or a relationship between the power spectral density and information about a time domain location for sending the first signal;
a relationship between the upper power spectral density limit and information about a frequency domain location for sending the first signal, and/or a relationship between the power spectral density and information about a frequency domain location for sending the first signal;
transmit power and/or maximum transmit power for sending the first signal; or
information about a frequency domain width for sending the first signal, where the information about the frequency domain width includes at least one of the following: a bandwidth, a quantity of physical resource blocks, or a sub-channel size.

Optionally, each terminal corresponds to first information of the terminal;
each frequency band corresponds to first information of the frequency band;
each carrier group corresponds to first information of the carrier group;
each carrier corresponds to first information of the carrier;
each bandwidth part corresponds to first information of the bandwidth part; or
each resource pool corresponds to first information of the resource pool.

Optionally, the first information is carried by at least one of the following:
radio resource control RRC signaling;
medium access control MAC signaling; or
downlink control information DCI signaling.

Optionally, the first signal is a signal transmitted based on one of the following:
a sidelink;
WiFi;
ultra-wideband transmission;
a heterogeneous network;
cellular communication; or
Bluetooth transmission.

It may be learned from the technical solution in the foregoing embodiment that, in this embodiment of this application, the first information is sent to the first terminal, and the first information is used to indicate, to the first terminal, the upper power spectral density limit and/or the power spectral density for sending the first signal, so that the power spectral density for sending the first signal is effectively controlled, interference to other transmission in a same time-frequency resource as the sent first signal is reduced, and radio resource utilization is improved.

The signal sending apparatus in this embodiment of this application may be an electronic device, for example, an electronic device with an operating system; or may be a component, for example, an integrated circuit or a chip, in an electronic device. The electronic device may be a terminal, or may be another device different from a terminal. For example, the terminal may include but is not limited to the foregoing listed types of the terminal 11. The another device may be a server, a network attached storage (NAS), or the like. This is not specifically limited in this embodiment of this application.

The signal sending apparatus provided in this embodiment of this application can implement processes implemented in the method embodiment in FIG. 4, and achieve same technical effects. To avoid repetition, details are not described herein again.

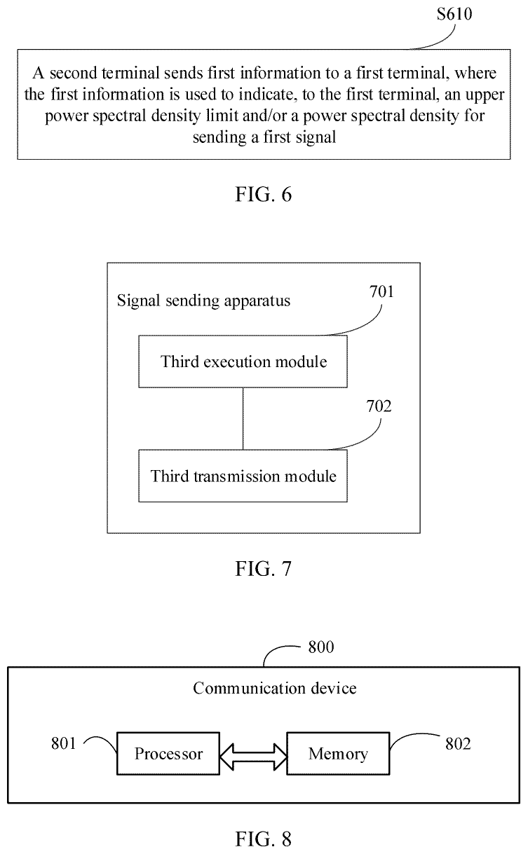

As shown in FIG. 6, an embodiment of this application provides a signal sending method. The method is performed by a second terminal. In other words, the method may be performed by software or hardware installed in the second terminal. The method includes the following steps.

S610: The second terminal sends first information to a first terminal, where the first information is used to indicate, to the first terminal, an upper power spectral density limit and/or a power spectral density for sending a first signal.

The first information includes at least one of the following:
the upper power spectral density limit and/or the power spectral density for sending the first signal;
a relationship between the upper power spectral density limit and reference signal received power RSRP, and/or a relationship between the power spectral density and reference signal received power RSRP;
a relationship between the upper power spectral density limit and a pathloss, and/or a relationship between the power spectral density and a pathloss;
a relationship between the upper power spectral density limit and a terminal received beam, and/or a relationship between the power spectral density and a terminal received beam;
a relationship between the upper power spectral density limit and a service type, and/or a relationship between the power spectral density and a service type;
a relationship between the upper power spectral density limit and a service priority, and/or a relationship between the power spectral density and a service priority;
a relationship between the upper power spectral density limit and a service congestion degree, and/or a relationship between the power spectral density and a service congestion degree;
a relationship between the upper power spectral density limit and received signal strength, and/or a relationship between the power spectral density and received signal strength;
a relationship between the upper power spectral density limit and a channel busy degree, and/or a relationship between the power spectral density and a channel busy degree;
a relationship between the upper power spectral density limit and information about a time domain location for sending the first signal, and/or a relationship between the power spectral density and information about a time domain location for sending the first signal;
a relationship between the upper power spectral density limit and information about a frequency domain location for sending the first signal, and/or a relationship between the power spectral density and information about a frequency domain location for sending the first signal;
transmit power and/or maximum transmit power for sending the first signal; or
information about a frequency domain width for sending the first signal, where the information about the frequency domain width includes at least one of the following: a bandwidth, a quantity of physical resource blocks, or a sub-channel size.

Optionally, each terminal corresponds to first information of the terminal;
each frequency band corresponds to first information of the frequency band;
each carrier group corresponds to first information of the carrier group;
each carrier corresponds to first information of the carrier;
each bandwidth part corresponds to first information of the bandwidth part; or
each resource pool corresponds to first information of the resource pool.

Optionally, the first information is carried by at least one of the following:
radio resource control RRC signaling;
medium access control MAC signaling; or
physical layer signaling.

Optionally, the first signal is a signal transmitted based on one of the following:
a sidelink;
WiFi;
ultra-wideband transmission;
a heterogeneous network;
cellular communication; or
Bluetooth transmission.

It may be learned from the technical solution in the foregoing embodiment that, in this embodiment of this application, the first information is sent to the first terminal, and the first information is used to indicate, to the first terminal, the upper power spectral density limit and/or the power spectral density for sending the first signal, so that the power spectral density for sending the first signal is effectively controlled, interference to other transmission in a same time-frequency resource as the sent first signal is reduced, and radio resource utilization is improved.

The signal sending method provided in the embodiments of this application may be performed by a signal sending apparatus. In the embodiments of this application, the signal sending apparatus provided in the embodiments of this application is described by using an example in which the signal sending apparatus performs the signal sending method.

As shown in FIG. 7, the signal sending apparatus includes a third execution module 701 and a third transmission module 702.

The third execution module 701 is configured to determine first information. The third transmission module 702 is configured to send the first information to a first terminal, where the first information is used to indicate, to the first terminal, an upper power spectral density limit and/or a power spectral density for sending a first signal.

The first information includes at least one of the following:
the upper power spectral density limit and/or the power spectral density for sending the first signal;
a relationship between the upper power spectral density limit and reference signal received power RSRP, and/or a relationship between the power spectral density and reference signal received power RSRP;
a relationship between the upper power spectral density limit and a pathloss, and/or a relationship between the power spectral density and a pathloss;
a relationship between the upper power spectral density limit and a terminal received beam, and/or a relationship between the power spectral density and a terminal received beam;
a relationship between the upper power spectral density limit and a service type, and/or a relationship between the power spectral density and a service type;
a relationship between the upper power spectral density limit and a service priority, and/or a relationship between the power spectral density and a service priority;
a relationship between the upper power spectral density limit and a service congestion degree, and/or a relationship between the power spectral density and a service congestion degree;
a relationship between the upper power spectral density limit and received signal strength, and/or a relationship between the power spectral density and received signal strength;
a relationship between the upper power spectral density limit and a channel busy degree, and/or a relationship between the power spectral density and a channel busy degree;
a relationship between the upper power spectral density limit and information about a time domain location for sending the first signal, and/or a relationship between the power spectral density and information about a time domain location for sending the first signal;
a relationship between the upper power spectral density limit and information about a frequency domain location for sending the first signal, and/or a relationship between the power spectral density and information about a frequency domain location for sending the first signal;
transmit power and/or maximum transmit power for sending the first signal; or
information about a frequency domain width for sending the first signal, where the information about the frequency domain width includes at least one of the following: a bandwidth, a quantity of physical resource blocks, or a sub-channel size.

Optionally, each terminal corresponds to first information of the terminal;
each frequency band corresponds to first information of the frequency band;
each carrier group corresponds to first information of the carrier group;
each carrier corresponds to first information of the carrier;
each bandwidth part corresponds to first information of the bandwidth part; or
each resource pool corresponds to first information of the resource pool.

Optionally, the first information is carried by at least one of the following:
radio resource control RRC signaling;
medium access control MAC signaling; or
physical layer signaling.

Optionally, the first signal is a signal transmitted based on one of the following:
a sidelink;
WiFi;
ultra-wideband transmission;
a heterogeneous network;
cellular communication; or
Bluetooth transmission.

It may be learned from the technical solution in the foregoing embodiment that, in this embodiment of this application, the first information is sent to the first terminal, and the first information is used to indicate, to the first terminal, the upper power spectral density limit and/or the power spectral density for sending the first signal, so that the power spectral density for sending the first signal is effectively controlled, interference to other transmission in a same time-frequency resource as the sent first signal is reduced, and radio resource utilization is improved.

The signal sending apparatus in this embodiment of this application may be an electronic device, for example, an electronic device with an operating system; or may be a component, for example, an integrated circuit or a chip, in an electronic device. The electronic device may be a terminal, or may be another device different from a terminal. For example, the terminal may include but is not limited to the foregoing listed types of the terminal 11. The another device may be a server, a network attached storage (NAS), or the like. This is not specifically limited in this embodiment of this application.

The signal sending apparatus provided in this embodiment of this application can implement processes implemented in the method embodiment in FIG. 6, and achieve same technical effects. To avoid repetition, details are not described herein again.

Optionally, as shown in FIG. 8, an embodiment of this application further provides a communication device 800, including a processor 801 and a memory 802. The memory 802 stores a program or instructions capable of running on the processor 801. For example, when the communication device 800 is a terminal, the program or the instructions are executed by the processor 801 to implement the steps in the foregoing signal sending method embodiment, and same technical effects can be achieved. When the communication device 800 is a network-side device, the program or the instructions are executed by the processor 801 to implement the steps in the foregoing signal sending method embodiment, and same technical effects can be achieved. To avoid repetition, details are not described herein again.

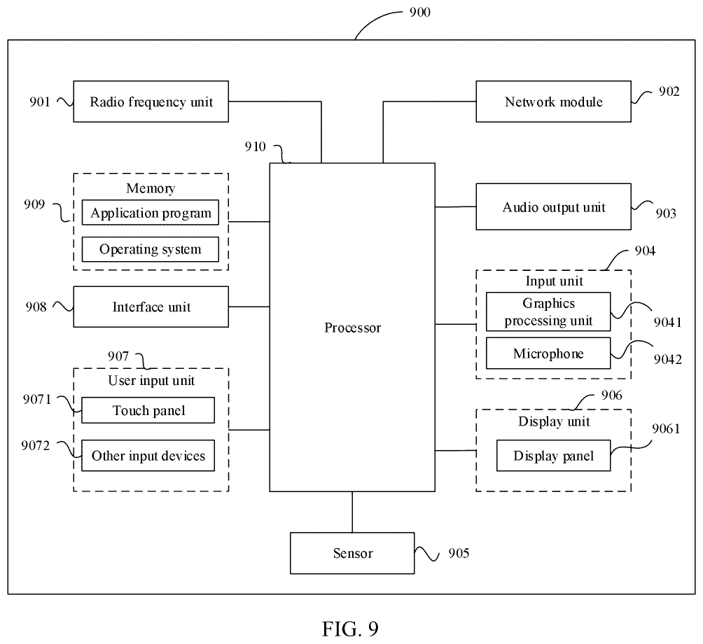

An embodiment of this application further provides a terminal, including a processor and a communication interface. The processor is configured to determine an upper power spectral density limit and/or a power spectral density for sending a first signal, based on first information. The communication interface is configured to send the first signal based on the upper power spectral density limit and/or the power spectral density. This terminal embodiment corresponds to the foregoing terminal-side method embodiments. Each implementing process and implementation of the foregoing method embodiments are applicable to this terminal embodiment, and same technical effects can be achieved. Specifically, FIG. 9 is a schematic diagram of a hardware structure of a terminal for implementing an embodiment of this application.

The terminal 900 includes but is not limited to at least some of a radio frequency unit 901, a network module 902, an audio output unit 903, an input unit 904, a sensor 905, a display unit 906, a user input unit 907, an interface unit 908, a memory 909, a processor 910, and the like.

A person skilled in the art may understand that the terminal 900 may further include a power supply (for example, a battery) that supplies power to each component, and the power supply may be logically connected to the processor 910 through a power management system, to implement functions such as charging management, discharging management, and power consumption management through the power management system. The structure of the terminal shown in FIG. 9 does not constitute a limitation on the terminal. The terminal may include more or fewer components than those shown in the figure, or combine some components, or have different component arrangements. Details are not described herein.

It should be understood that in this embodiment of this application, the input unit 904 may include a graphics processing unit (GPU) 9041 and a microphone 9042. The graphics processing unit 9041 processes image data of a still picture or a video obtained by an image capture apparatus (for example, a camera) in a video capture mode or an image capture mode. The display unit 906 may include a display panel 9061, and the display panel 9061 may be configured in a form of a liquid crystal display, an organic light-emitting diode, or the like. The user input unit 907 includes at least one of a touch panel 9071 or other input devices 9072. The touch panel 9071 is also referred to as a touchscreen. The touch panel 9071 may include two parts: a touch detection apparatus and a touch controller. The other input devices 9072 may include but are not limited to a physical keyboard, a function key (such as a volume control key or an on/off key), a trackball, a mouse, and a joystick. Details are not described herein.

In this embodiment of this application, after receiving downlink data from a network-side device, the radio frequency unit 901 may transmit the downlink data to the processor 910 for processing. In addition, the radio frequency unit 901 may send uplink data to the network-side device. Generally, the radio frequency unit 901 includes but is not limited to an antenna, an amplifier, a transceiver, a coupler, a low-noise amplifier, a duplexer, and the like.

The memory 909 may be configured to store a software program or instructions and various types of data. The memory 909 may mainly include a first storage area for storing a program or instructions and a second storage area for storing data. The first storage area may store an operating system, an application program or instructions required by at least one function (for example, a sound play function or an image play function), and the like. In addition, the memory 909 may include a volatile memory or a non-volatile memory, or the memory 909 may include both a volatile memory and a non-volatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synch link dynamic random access memory (Synch Link DRAM, SLDRAM), and a direct rambus random access memory (Direct Rambus RAM, DRRAM). The memory 909 in this embodiment of this application includes but is not limited to these memories and any other suitable type of memory.

The processor 910 may include one or more processing units. Optionally, the processor 910 integrates an application processor and a modem processor. The application processor mainly processes operations related to an operating system, a user interface, an application program, and the like. The modem processor, for example, a baseband processor, mainly processes a wireless communication signal. It may be understood that, the foregoing modem processor may not be integrated into the processor 910.

The radio frequency unit 901 is configured to send a first signal based on an upper power spectral density limit and/or a power spectral density.

The processor 910 is configured to determine the upper power spectral density limit and/or the power spectral density for sending the first signal, based on first information.

The first information includes at least one of the following:
the upper power spectral density limit and/or the power spectral density for sending the first signal;
a relationship between the upper power spectral density limit and reference signal received power RSRP, and/or a relationship between the power spectral density and reference signal received power RSRP;
a relationship between the upper power spectral density limit and a pathloss, and/or a relationship between the power spectral density and a pathloss;
a relationship between the upper power spectral density limit and a terminal received beam, and/or a relationship between the power spectral density and a terminal received beam;
a relationship between the upper power spectral density limit and a service type, and/or a relationship between the power spectral density and a service type;
a relationship between the upper power spectral density limit and a service priority, and/or a relationship between the power spectral density and a service priority;
a relationship between the upper power spectral density limit and a service congestion degree, and/or a relationship between the power spectral density and a service congestion degree;
a relationship between the upper power spectral density limit and received signal strength, and/or a relationship between the power spectral density and received signal strength;
a relationship between the upper power spectral density limit and a channel busy degree, and/or a relationship between the power spectral density and a channel busy degree;
a relationship between the upper power spectral density limit and information about a time domain location for sending the first signal, and/or a relationship between the power spectral density and information about a time domain location for sending the first signal;
a relationship between the upper power spectral density limit and information about a frequency domain location for sending the first signal, and/or a relationship between the power spectral density and information about a frequency domain location for sending the first signal;
transmit power and/or maximum transmit power for sending the first signal; or
information about a frequency domain width for sending the first signal, where the information about the frequency domain width includes at least one of the following: a bandwidth, a quantity of physical resource blocks, or a sub-channel size.

Optionally, each terminal corresponds to first information of the terminal;
each frequency band corresponds to first information of the frequency band;
each carrier group corresponds to first information of the carrier group;
each carrier corresponds to first information of the carrier;
each bandwidth part corresponds to first information of the bandwidth part; or
each resource pool corresponds to first information of the resource pool.

Optionally, the first information is carried by at least one of the following sent by the network-side device:
radio resource control RRC signaling;
medium access control MAC signaling; or
downlink control information DCI signaling.

Optionally, the first information is carried by at least one of the following sent by a second terminal:
radio resource control RRC signaling;
medium access control MAC signaling; or
physical layer signaling.

Optionally, the first signal is a signal transmitted based on one of the following:
a sidelink;
WiFi;
ultra-wideband transmission;
a heterogeneous network;
cellular communication; or
Bluetooth transmission.

In this embodiment of this application, the power spectral density for sending the first signal is effectively controlled, interference to other transmission in a same time-frequency resource as the sent first signal is reduced, and radio resource utilization is improved.

An embodiment of this application further provides a network-side device, including a processor and a communication interface. The processor is configured to determine first information. The communication interface is configured to send the first information to a first terminal, where the first information is used to indicate, to the first terminal, an upper power spectral density limit and/or a power spectral density for sending a first signal. This network-side device embodiment corresponds to the foregoing network-side device method embodiments. Each implementing process and implementation of the foregoing method embodiments are applicable to this network-side device embodiment, and same technical effects can be achieved.

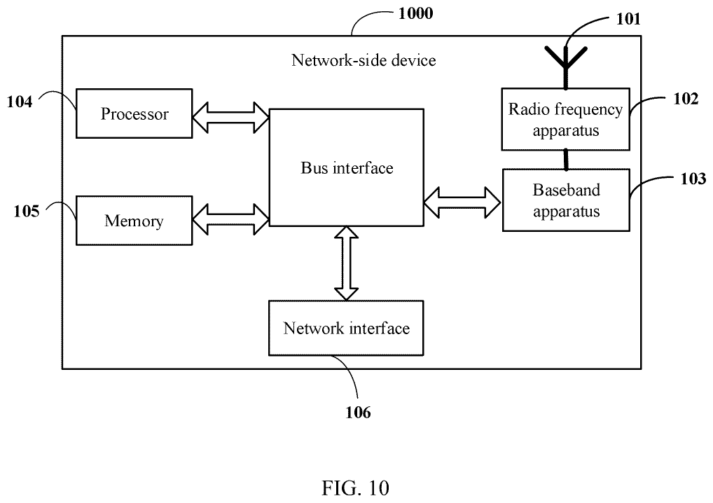

Specifically, an embodiment of this application further provides a network-side device. As shown in FIG. 10, the network-side device 1000 includes an antenna 101, a radio frequency apparatus 102, a baseband apparatus 103, a processor 104, and a memory 105. The antenna 101 is connected to the radio frequency apparatus 102. In an uplink direction, the radio frequency apparatus 102 receives information through the antenna 101, and sends the received information to the baseband apparatus 103 for processing. In a downlink direction, the baseband apparatus 103 processes to-be-sent information, and sends processed information to the radio frequency apparatus 102. After processing the received information, the radio frequency apparatus 102 sends processed information through the antenna 101.

The method performed by the network-side device in the foregoing embodiment may be implemented in the baseband apparatus 103. The baseband apparatus 103 includes a baseband processor.

For example, the baseband apparatus 103 may include at least one baseband board. A plurality of chips are disposed on the baseband board. As shown in FIG. 10, one of the chips is, for example, the baseband processor, and is connected to the memory 105 through a bus interface, to invoke a program in the memory 105 to perform the operation of the network-side device shown in the foregoing method embodiment.

The network-side device may further include a network interface 106. For example, the interface is a common public radio interface (CPRI).

Specifically, the network-side device 1000 in this embodiment of the present invention further includes instructions or a program stored in the memory 105 and capable of running on the processor 104. The processor 104 invokes the instructions or the program in the memory 105 to perform the method performed by the modules shown in FIG. 5, and same technical effects are achieved. To avoid repetition, details are not described herein again.

An embodiment of this application further provides a readable storage medium. The readable storage medium stores a program or instructions. When the program or the instructions are executed by a processor, the processes in the foregoing signal sending method embodiment are implemented, and same technical effects can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface. The communication interface is coupled to the processor. The processor is configured to run a program or instructions to implement the processes in the foregoing signal sending method embodiment, and same technical effects can be achieved. To avoid repetition, details are not described herein again.

It should be understood that, the chip mentioned in this embodiment of this application may also be referred to as a system-level chip, a system chip, a chip system, or a system on chip.

An embodiment of this application further provides a computer program/program product. The computer program/program product is stored in a storage medium. The computer program/program product is executed by at least one processor to implement the processes in the foregoing signal sending method embodiment, and same technical effects can be achieved. To avoid repetition, details are not described herein again.

An embodiment of this application further provides a signal sending system, including a terminal and a network-side device. The terminal may be configured to perform the steps of the foregoing signal sending method, and the network-side device may be configured to perform the steps of the foregoing signal sending method.

It should be noted that in this specification, the term “comprise”, “include”, or any of their variants is intended to cover a non-exclusive inclusion, so that a process, a method, an article, or an apparatus that includes a list of elements not only includes those elements but also includes other elements that are not expressly listed, or further includes elements inherent to such a process, a method, an article, or an apparatus. Without more constraints, an element preceded by “includes a . . . ” does not preclude the existence of additional identical elements in the process, method, article, or apparatus that includes the element. In addition, it should be noted that, the scope of the method and apparatus in the implementations of this application is not limited to performing functions in an order shown or discussed, and may further include performing functions in a basically simultaneous manner or in a reverse order based on the functions involved. For example, the described method may be performed in an order different from the order described, and various steps may be added, omitted, or combined. In addition, features described with reference to some examples may be combined in other examples.

According to the foregoing descriptions of the implementations, a person skilled in the art may clearly understand that the method in the foregoing embodiments may be implemented by software and a necessary general-purpose hardware platform, or certainly may be implemented by hardware. However, in many cases, the former is a better implementation. Based on such an understanding, the technical solutions of this application essentially or the part contributing to the prior art may be implemented in a form of a computer software product. The computer software product is stored in a storage medium (for example, a ROM/RAM, a magnetic disk, or an optical disc), and includes several instructions for instructing a terminal (which may be a mobile phone, a computer, a server, an air conditioner, a network device, or the like) to perform the methods described in the embodiments of this application.

The foregoing describes the embodiments of this application with reference to the accompanying drawings. However, this application is not limited to the foregoing specific implementations. The foregoing specific implementations are merely illustrative rather than restrictive. Inspired by this application, a person of ordinary skill in the art may develop many other manners without departing from principles of this application and the protection scope of the claims, and all such manners fall within the protection scope of this application.

1. A signal sending method, comprising:
determining an upper power spectral density limit and/or a power spectral density for sending a first signal, by a first terminal based on first information; and
sending, by the first terminal, the first signal based on the upper power spectral density limit and/or the power spectral density, wherein
the first information comprises at least one of the following:
the upper power spectral density limit and/or the power spectral density for sending the first signal;
a relationship between the upper power spectral density limit and reference signal received power RSRP, and/or a relationship between the power spectral density and reference signal received power RSRP;
a relationship between the upper power spectral density limit and a pathloss, and/or a relationship between the power spectral density and a pathloss;
a relationship between the upper power spectral density limit and a terminal received beam, and/or a relationship between the power spectral density and a terminal received beam;
a relationship between the upper power spectral density limit and a service type, and/or a relationship between the power spectral density and a service type;
a relationship between the upper power spectral density limit and a service priority, and/or a relationship between the power spectral density and a service priority;
a relationship between the upper power spectral density limit and a service congestion degree, and/or a relationship between the power spectral density and a service congestion degree;
a relationship between the upper power spectral density limit and received signal strength, and/or a relationship between the power spectral density and received signal strength;
a relationship between the upper power spectral density limit and a channel busy degree, and/or a relationship between the power spectral density and a channel busy degree;
a relationship between the upper power spectral density limit and information about a time domain location for sending the first signal, and/or a relationship between the power spectral density and information about a time domain location for sending the first signal;
a relationship between the upper power spectral density limit and information about a frequency domain location for sending the first signal, and/or a relationship between the power spectral density and information about a frequency domain location for sending the first signal;
transmit power and/or maximum transmit power for sending the first signal; or
information about a frequency domain width for sending the first signal, wherein the information about the frequency domain width comprises at least one of the following: a bandwidth, a quantity of physical resource blocks, or a sub-channel size.

2. The method according to claim 1, wherein
each terminal corresponds to first information of the terminal;
each frequency band corresponds to first information of the frequency band;
each carrier group corresponds to first information of the carrier group;
each carrier corresponds to first information of the carrier;
each bandwidth part corresponds to first information of the bandwidth part; or
each resource pool corresponds to first information of the resource pool.

3. The method according to claim 1, wherein the first information is carried by at least one of the following sent by a network-side device:
radio resource control RRC signaling;
medium access control MAC signaling; or
downlink control information DCI signaling.

4. The method according to claim 1, wherein the first information is carried by at least one of the following sent by a second terminal:
radio resource control RRC signaling;
medium access control MAC signaling; or
physical layer signaling.

5. The method according to claim 1, wherein the first signal is a signal transmitted based on one of the following:
a sidelink;
WiFi;
ultra-wideband transmission;
a heterogeneous network;
cellular communication; or
Bluetooth transmission.

6. A signal sending method, comprising:
sending, by a network-side device, first information to a first terminal, wherein the first information is used to indicate, to the first terminal, an upper power spectral density limit and/or a power spectral density for sending a first signal, wherein
the first information comprises at least one of the following:
the upper power spectral density limit and/or the power spectral density for sending the first signal;
a relationship between the upper power spectral density limit and reference signal received power RSRP, and/or a relationship between the power spectral density and reference signal received power RSRP;
a relationship between the upper power spectral density limit and a pathloss, and/or a relationship between the power spectral density and a pathloss;
a relationship between the upper power spectral density limit and a terminal received beam, and/or a relationship between the power spectral density and a terminal received beam;
a relationship between the upper power spectral density limit and a service type, and/or a relationship between the power spectral density and a service type;
a relationship between the upper power spectral density limit and a service priority, and/or a relationship between the power spectral density and a service priority;
a relationship between the upper power spectral density limit and a service congestion degree, and/or a relationship between the power spectral density and a service congestion degree;
a relationship between the upper power spectral density limit and received signal strength, and/or a relationship between the power spectral density and received signal strength;
a relationship between the upper power spectral density limit and a channel busy degree, and/or a relationship between the power spectral density and a channel busy degree;
a relationship between the upper power spectral density limit and information about a time domain location for sending the first signal, and/or a relationship between the power spectral density and information about a time domain location for sending the first signal;
a relationship between the upper power spectral density limit and information about a frequency domain location for sending the first signal, and/or a relationship between the power spectral density and information about a frequency domain location for sending the first signal;
transmit power and/or maximum transmit power for sending the first signal; or
information about a frequency domain width for sending the first signal, wherein the information about the frequency domain width comprises at least one of the following: a bandwidth, a quantity of physical resource blocks, or a sub-channel size.

7. The method according to claim 6, wherein a resource scheduled by the network-side device for the first signal overlaps another scheduled resource.

8. The method according to claim 6, wherein
each terminal corresponds to first information of the terminal;
each frequency band corresponds to first information of the frequency band;
each carrier group corresponds to first information of the carrier group;
each carrier corresponds to first information of the carrier;
each bandwidth part corresponds to first information of the bandwidth part; or
each resource pool corresponds to first information of the resource pool.

9. The method according to claim 6, wherein the first information is carried by at least one of the following:
radio resource control RRC signaling;
medium access control MAC signaling; or
downlink control information DCI signaling.

10. The method according to claim 6, wherein the first signal is a signal transmitted based on one of the following:
a sidelink;
WiFi;
ultra-wideband transmission;
a heterogeneous network;
cellular communication; or
Bluetooth transmission.

11. A signal sending method, comprising:
sending, by a second terminal, first information to a first terminal, wherein the first information is used to indicate, to the first terminal, an upper power spectral density limit and/or a power spectral density for sending a first signal, wherein
the first information comprises at least one of the following:
the upper power spectral density limit and/or the power spectral density for sending the first signal;
a relationship between the upper power spectral density limit and reference signal received power RSRP, and/or a relationship between the power spectral density and reference signal received power RSRP;
a relationship between the upper power spectral density limit and a pathloss, and/or a relationship between the power spectral density and a pathloss;
a relationship between the upper power spectral density limit and a terminal received beam, and/or a relationship between the power spectral density and a terminal received beam;
a relationship between the upper power spectral density limit and a service type, and/or a relationship between the power spectral density and a service type;
a relationship between the upper power spectral density limit and a service priority, and/or a relationship between the power spectral density and a service priority;
a relationship between the upper power spectral density limit and a service congestion degree, and/or a relationship between the power spectral density and a service congestion degree;
a relationship between the upper power spectral density limit and received signal strength, and/or a relationship between the power spectral density and received signal strength;
a relationship between the upper power spectral density limit and a channel busy degree, and/or a relationship between the power spectral density and a channel busy degree;
a relationship between the upper power spectral density limit and information about a time domain location for sending the first signal, and/or a relationship between the power spectral density and information about a time domain location for sending the first signal;
a relationship between the upper power spectral density limit and information about a frequency domain location for sending the first signal, and/or a relationship between the power spectral density and information about a frequency domain location for sending the first signal;
transmit power and/or maximum transmit power for sending the first signal; or
information about a frequency domain width for sending the first signal, wherein the information about the frequency domain width comprises at least one of the following: a bandwidth, a quantity of physical resource blocks, or a sub-channel size.

12. The method according to claim 11, wherein
each terminal corresponds to first information of the terminal;
each frequency band corresponds to first information of the frequency band;
each carrier group corresponds to first information of the carrier group;
each carrier corresponds to first information of the carrier;
each bandwidth part corresponds to first information of the bandwidth part; or
each resource pool corresponds to first information of the resource pool.

13. The method according to claim 11, wherein the first information is carried by at least one of the following:
radio resource control RRC signaling;
medium access control MAC signaling; or
physical layer signaling.

14. The method according to claim 11, wherein the first signal is a signal transmitted based on one of the following:
a sidelink;
WiFi;
ultra-wideband transmission;
a heterogeneous network;
cellular communication; or
Bluetooth transmission.

15. A terminal, comprising a processor and a memory, wherein the memory stores a program or instructions capable of running on the processor, and the program or the instructions, when executed by the processor, implement the signal sending method according to claim 1.

16. A network-side device, comprising a processor and a memory, wherein the memory stores a program or instructions capable of running on the processor, and the program or the instructions, when executed by the processor, implement the steps of the signal sending method according to claim 6.

17. A terminal, comprising a processor and a memory, wherein the memory stores a program or instructions capable of running on the processor, and the program or the instructions, when executed by the processor, implement the signal sending method according to claim 11.

18. A readable storage medium, wherein the readable storage medium stores a program or instructions, and the program or the instructions, when executed by a processor, implement the signal sending method according to claim 1.

19. A readable storage medium, wherein the readable storage medium stores a program or instructions, and the program or the instructions, when executed by a processor, implement the signal sending method according to claim 6.

20. A readable storage medium, wherein the readable storage medium stores a program or instructions, and the program or the instructions, when executed by a processor, implement the signal sending method according to claim 11.
